(19) United States
(12) Patent Application Publication
(10) Pub. No.: US 2025/0384634 A1
(43) Pub. Date: Dec. 18, 2025

(54) AUTOMATED FORMATION GROUP GUIDANCE METHOD BASED ON SCENE PERCEPTION

(71) Applicant: Beihang University, Beijing (CN)

(72) Inventors: Lili WANG, Beijing (CN); Jian WU, Beijing (CN); Dong ZHOU, Beijing (CN); Qinping ZHAO, Beijing (CN); Yanzhou CHEN, Beijing (CN)

(21) Appl. No.: 18/925,840

(22) Filed: Oct. 24, 2024

(30) Foreign Application Priority Data
Jun. 12, 2024 (CN) 202410757078.1

(51) Int. Cl. G06T 19/00

(52) U.S. Cl. CPC G06T 19/003; G06T 2219/024

(57) ABSTRACT

Embodiments of this disclosure propose an automated formation group guidance method based on scene perception. One implementation of this method includes: in response to receiving jump position information, determining whether a jump position corresponding to the jump position information is within any exhibit area; in response to determining that the jump position is within any exhibit area, based on a social distance threshold and a queue length, determining an initial visit position queue corresponding to a target exhibit; optimizing each initial visit position to obtain an optimized visit position queue; based on a preset matching strategy, matching the optimized visit position queue and a current visitor position information queue to obtain a target visitor position information queue, for guiding each visitor to perform position jumps and browse target exhibits.

### CROSS-REFERENCE TO RELATED APPLICATION

This application claims priority from the Chinese patent application 202410757078.1 filed Jun. 12, 2024, the content of which is incorporated herein in the entirety by reference.

### TECHNICAL FIELD

Embodiments of this disclosure relate to the fields of computer graphics and virtual reality, and specifically to an automated formation group guidance method based on scene perception.

### BACKGROUND

In the field of virtual reality (VR), more and more virtual reality navigation techniques allow users to freely and quickly browse the content of virtual spaces. However, there is a lack of guidance techniques for teams in many scenarios, such as museums and scenes of cultural tourism. Therefore, group guidance techniques emerge, aiming to overcome the limitations of personal navigation. In a group guidance system, navigation instructions are in the charge of one member, while other members move according to the navigation instructions. This method improves navigation efficiency and reduces the repetition of navigation instructions, which can help VR users interact and explore the virtual world more effectively, and reduce various problems related to personal navigation.

However, existing group guidance techniques require a guide to select suitable positions for each team member. On the one hand, the guide needs to choose suitable positions to ensure that there are no collisions between different members or between the members and the scene objects; On the other hand, the guide needs to choose a better position for each member to ensure a good browsing experience. Due to the fact that the above group guidance process requires the guide to observe before manually select the position, the operation of the guide in planning the navigation route and the user's viewing position is too cumbersome, resulting in a decrease in the efficiency of group navigation.

The information disclosed above is only for enhancing the understanding of the background of the conception of this disclosure, so it may contain information that does not constitute the existing art known to a person having ordinary skill in the art in this country.

### SUMMARY

The content of this disclosure is to briefly introduce conceptions, which will be described in detail in the section of detailed description of the disclosure later. The content of this disclosure is not intended to identify key or necessary features of the claimed technical solution, nor is it intended to limit the scope of the claimed technical solution.

To solve the technical problems mentioned in the background section above, some embodiments of this disclosure propose an automated formation group guidance method based on scene perception, the method comprising: in response to receiving jump position information for a browsing area, determining whether the jump position corresponding to the jump position information is within any exhibit area, wherein the browsing area includes a non-exhibit area and at least one exhibit area, and each exhibit area in the at least one exhibit area corresponds to an exhibit; in response to determining that the jump position is within the any exhibit area, based on a preset social distance threshold and a queue length, determining an initial visit position queue corresponding to a target exhibit, where the target exhibit is the exhibit exhibited in a target exhibit area, the target exhibit area is an exhibit area that includes the jump position, and the queue length is the number of respective visitors in a visitor group; optimizing each initial visit position in the initial visit position queue to obtain an optimized visit position queue, wherein each optimized visit position in the optimized visit position queue is a viewpoint position with a higher quality of a view, the view being an image when viewing the exhibit through virtual reality equipment; based on a preset matching strategy, matching the optimized visit position queue and the current visitor position information queue to obtain a target visitor position information queue, for guiding each visitor in the visitor group to perform position jumps and browse target exhibits, wherein the matching strategy is to minimize the sum of the various position deflection angles of the respective visitors, and a position deflection angle is the angle between the position orientation before jump and the position orientation after jump of the visitor, which is less than a preset degree.

The above embodiments of this disclosure have the following beneficial effects: through the automated formation group guidance method based on scene perception in some embodiments of this disclosure, the efficiency of group navigation may be improved. To be specific, in order to solve the technical problem of “reduced efficiency of group navigation” mentioned in the background section, the automated formation group guidance method based on scene perception in some embodiments of this disclosure, after the guide determines the next target exhibit to be viewed, first generates an initial visit position queue for the visitor group based on the jump position corresponding to the target exhibit selected by the guide, then optimizes the position of the initial visit position queue to obtain an optimized visit position queue, thus obtains various viewpoint positions with higher view quality when viewing exhibits, for subsequent allocation to each visitor, and in the end, based on a preset matching strategy, matches the optimized visit position queue and the current visitor position information queue to obtain a target visitor position information queue, for guiding each visitor in the visitor group to perform position jumps and browse target exhibits, wherein the matching strategy is to minimize the sum of the position deflection angles before and after all visitor jumps. Therefore, each visitor can match and jump to an optimized visit position with higher view quality, for better observation of the target exhibits. Therefore, the automated formation group guidance method based on scene perception in some embodiments of this disclosure can simplify the operation of the guide in planning the navigation route and the user's viewing position, reduce the burden and fatigue of the guide, and improve the efficiency of group navigation by automatically generating various jump positions with better exhibit observation effects for the visitor group after the guide selects a jump position. Also, because the view quality corresponding to each optimized visit position is relatively high, it can improve the viewing experience of visitors when viewing exhibits. In addition, by adopting the strategy of minimizing the sum of the position deviation angles before and after all visitor jumps, matching and optimizing the visit position for each visitor can also significantly reduce the probability of 3D (three-dimensional) dizziness caused by excessive position deviation angles before and after jumps, thereby further improving the viewing experience of visitors.

### BRIEF DESCRIPTION OF THE DRAWINGS

The above and other features, advantages, and aspects of the embodiments of this disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of the automated formation group guidance method based on scene perception according to this disclosure;

FIG. 2 is a schematic diagram of the scene where an optimized visit position queue is generated in a circular exhibit area of the automated formation group guidance method based on scene perception according to this disclosure;

FIG. 3 is a schematic diagram of the scene where an optimized visit position queue is generated in an arc-shaped exhibit area of the automated formation group guidance method based on scene perception according to this disclosure;

FIG. 4 is a schematic diagram of each viewpoint score corresponding to the optimized visit position queue of the automated formation group guidance method based on scene perception according to this disclosure;

FIG. 5 is a schematic diagram of the comparison before and after position jump of the automated formation group guidance method based on scene perception according to this disclosure.

### DETAILED DESCRIPTION OF THE INVENTION

Hereinafter, the embodiments of this disclosure will be described in more detail with reference to the accompanying drawings. Although certain embodiments of this disclosure are shown in the drawings, it should be understood that this disclosure may be implemented in various forms, and shall not be construed as being limited to the embodiments set forth herein. On the contrary, these embodiments are provided for a more thorough and complete understanding of this disclosure. It should be understood that the drawings and embodiments of this disclosure are used only for illustrative purposes, not to limit the protection scope of this disclosure.

Besides, it should be noted that, for ease of description, only the portions related to the relevant invention are shown in the drawings. In the case of no conflict, the embodiments in this disclosure and the features in the embodiments may be combined with each other.

It should be noted that such concepts as “first” and “second” mentioned in this disclosure are only used to distinguish different devices, modules or units, and are not used to limit the order of functions performed by these devices, modules or units or interdependence thereof.

It should be noted that such adjuncts as “one” and “more” mentioned in this disclosure are illustrative, not restrictive, and those skilled in the art should understand that, unless the context clearly indicates otherwise, they should be understood as “one or more”.

The names of messages or information exchanged between multiple devices in the embodiments of this disclosure are only for illustrative purposes, and are not intended to limit the scope of these messages or information.

This disclosure will be described in detail below with reference to the accompanying drawings and in conjunction with embodiments.

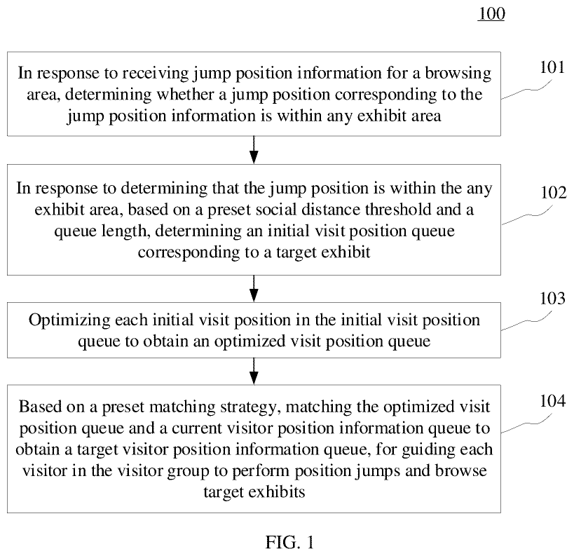

FIG. 1 illustrates a flow 100 of some embodiments of the automated formation group guidance method based on scene perception according to this disclosure. The automated formation group guidance method based on scene perception comprises the following steps:
Step 101: In response to receiving jump position information for a browsing area, determining whether the jump position corresponding to the jump position information is within any exhibit area.

In some embodiments, the executing body (such as a computing device) of the automated formation group guidance method based on scene perception may, in response to receiving jump position information for a browsing area, determine whether the jump position corresponding to the jump position information is within any exhibit area. Wherein, the browsing area may include a non-exhibit area and at least one exhibit area. The non-exhibit area may be a pre-set transition area for jumping between various exhibit areas. The exhibit area may be an area displaying exhibits for visitors to view. Each exhibit area in the at least one exhibit area may correspond to the exhibits one by one. The jump position information may be the information of the jump position selected by the guide through a VR controller. The guide may be the person responsible for guiding the visitor group to visit various exhibits in the browsing area. For example, the guide may be a tour guide or a museum guide. The visitor group may be a group composed of various visitors. The jump position information may be the coordinates of the jump position in the virtual reality scene. The jump position may be the landing point position selected by the guide for the next jump in the virtual reality scene. By means of map matching technology in virtual reality scenes, the jump position corresponding to the jump position information may be matched with the built-in browsing area map of the VR equipment to determine whether the jump position is within any of the exhibit areas included in the browsing area. Wherein, the browsing area map may be a VR map used for displaying the non-exhibit areas in the browsing area and the location division of each exhibit area.

As an example, if the next exhibit to be visited is rather far away from the current exhibit, then in the process of jumping from the current exhibit area to the next exhibit area, it is necessary to jump to a non-exhibit area for intermediate transition. If the next exhibit to be visited is fairly close to the current exhibit, one can directly jump from the area where the current exhibit is located to the area where the next exhibit is located.

Alternatively, each visitor in the visitor group meets a preset visitor position condition set. The preset visitor position condition set may be a preset condition set used to constrain the visitor's position and orientation. The preset visitor position condition set may include:
Condition 1: In response to determining that the jump position is within the any exhibit area, each visitor in the visitor group faces the centroid of the target exhibit. Wherein, the target exhibit may be the exhibit exhibited in the target exhibit area. The target exhibit area may be the exhibit area that includes the jump position.
Condition 2: The straight-line distance between the positions of any two visitors in the visitor group is not less than a social distance threshold. Wherein, the social distance threshold may be the lower limit of the straight-line distance between any two visitors.
Condition 3: Each visitor in the visitor group does not collide with obstacles. Wherein, obstacles may be objects that affect the movement of visitors in virtual reality scenes. For example, the obstacles may be, but are not limited to, one of the following: obstacle exhibits, pillars, walls. The obstacle exhibits may be other exhibits relative to the target exhibit.
Step 102: In response to determining that the jump position is within the any exhibit area, based on a preset social distance threshold and a queue length, determining an initial visit position queue corresponding to a target exhibit.

In some embodiments, the executing body may, in response to determining that the jump position is within the any exhibit area, based on a preset social distance threshold and queue length, determine through various means the initial visit position queue corresponding to the target exhibit. Wherein, the queue length is the number of respective visitors in a visitor group. The initial visit position queue may be composed of various initial visit positions that meet the social distance condition and the collision free condition. The initial visit positions in the initial visit position queue may be positions for visitors to observe the exhibits. The social distance condition may be that the straight-line distance between any two initial visit positions is not less than the social distance threshold. The collision free condition may be that there are no obstacles at each initial visit position.

In certain optional implementations of some embodiments, the executing body may determine the initial visit position queue corresponding to the target exhibit based on a preset social distance threshold and queue length through the following steps:

The first step is to determine whether the shape of the target exhibit area is circular or arc-shaped. Firstly, based on a preset spatial overlap detection method, determine whether there are walls within a preset distance range around the target exhibit. Wherein, the spatial overlap detection method may be a method for detecting the overlap between various items in the space. The preset distance range may be a circular area set in advance with the target exhibit as the center and the preset distance as the radius. Then, in response to determining that there are no walls within the preset distance range around the target exhibit, determine the shape of the target exhibit area to be circular. Lastly, in response to determining that there are walls within the preset distance range around the target exhibit, determine the shape of the target exhibit area to be an arc.

As an example, the spatial overlap detection method may be a geometric shape detection method.

The second step is, in response to determining that the shape of the target exhibit area is circular, to determine the radius of the circular area based on the set social distance threshold and queue length. Wherein, the radius of the circular area may be the radius of the circle corresponding to the target exhibit area. The radius of a circular area may be generated using the following formula:

$$r 1 = d / 2 sin ( π / n )$$

Wherein, r1 represents the radius of the circular area, d represents the social distance threshold, n represents the number of visit positions corresponding to the queue length, sin(⋅) represents the sine function.

The third step is, based on the radius of the circular area and the queue length, to determine the initial visit position queue corresponding to the target exhibit. Wherein, the initial visit position in the initial visit position queue may be generated by the following formula:

$$P [ i ] = e . p + r 1 \cdot ( cos ( 2 π \times i / n ) , sin ( 2 π \times i / n ) )$$

Wherein, P represents the initial visit position queue, i represents the sequence number of the initial visit positions in the initial visit position queue, P[i] represents the ith initial visit position in the initial visit position queue, e represents the target exhibit, P represents the position point, e.p represents the position of the exhibit, cos(⋅) represents the cosine function.

The fourth step is, for each initial visit position in the initial visit position queue, in response to determining the presence of obstacles at the initial visit position, to iteratively update the initial visit position using the following formula to obtain an initial visit position that meets condition 3:

$$\{ \begin{matrix}P [ i ] = e . p + ( r 1 - Δ ) \cdot ( cos ( 2 π \times \frac{i}{n} ) , sin ( 2 π \times \frac{i}{n} ) ) \\ Δ = Δ + δ\end{matrix} .$$

Wherein, δ represents an amount of the change in the distance that the initial visit position moves towards the target exhibit during each iterative update, Δ represents the distance of movement the initial visit position accumulates towards the target exhibit after each iterative update.

Alternatively, the executing body may also perform the following steps:
Step 1, in response to determining that the shape of the target exhibit area is arc-shaped, determine the radius of the arc-shaped area based on the social distance threshold and the queue length. Wherein, the radius of the arc-shaped area may be the radius of the arc corresponding to the target exhibit area. The radius of the arc-shaped area may be generated using the following formula:

$$r 2 = d / 2 sin ( \frac{{φ}_{1} - {φ}_{2}}{2 ( n - 1 )} ) .$$

Wherein, r2 represents the radius of the arc-shaped area, q represents the angle. In the target exhibit area, φ₁ represents the obtuse or right angle formed by the wall on one side of the target exhibit and the plane where the centroid of the target exhibit is located, φ₂ represents the acute angle formed between the wall on the other side of the target exhibit and the plane where the centroid of the target exhibit is located, φₑ-φₛ represents the angle between the walls on both sides of the target exhibit, which is also the central angle of the arc corresponding to the target exhibit area.
Step 2, based on the radius of the arc-shaped area and the queue length, determine the initial visiting position queue corresponding to the target exhibit. Wherein, the initial visit position in the initial visit position queue is generated by the following formula:

$$P [ i ] = e . p + r 2 \cdot ( cos ( \frac{i \times ( {φ}_{1} - {φ}_{2} )}{n - 1} ) , sin ( \frac{i \times ( {φ}_{1} - {φ}_{2} )}{n - 1} ) ) .$$

Step 3, for each initial visit position in the initial visit position queue, in response to determining the presence of obstacles at the initial visit position, iteratively update the initial visit position using the following formula to obtain an initial visit position that meets condition 3:

$$\{ \begin{matrix}P [ i ] = e . p + ( r 2 - Δ ) \cdot ( cos ( \frac{i \times ( {φ}_{1} - {φ}_{2} )}{n - 1} ) , sin ( \frac{i \times ( {φ}_{1} - {φ}_{2} )}{n - 1} ) ) \\ Δ = Δ + δ\end{matrix} .$$

Step 103: Optimizing each initial visit position in the initial visit position queue to obtain an optimized visit position queue.

In some embodiments, the executing body may optimize each initial visit position in the initial visit position queue through various means to obtain an optimized visit position queue, wherein each optimized visit position in the optimized visit position queue is a viewpoint position with higher quality of a view, the view being an image when the visitor views the exhibit through a virtual reality device. The viewpoint position may be the location where visitors view the exhibits in the virtual scene. The viewpoint position is also associated with orientation information. The orientation information may be the information of the orientation of visitors when viewing exhibits in a virtual scene.

In certain optional implementations of some embodiments, the executing body may perform the following steps for each initial visit position in the initial visit position queue to generate optimized visit positions in the optimized visit position queue:

Take the initial visit position mentioned above as the position to be optimized, and based on the position to be optimized, perform the following optimized visit position generating steps:

The first step is to determine a candidate transfer position group corresponding to the position to be optimized. Wherein, the candidate transfer position in the candidate transfer position group may be a position point that the position to be optimized can transfer to. The position to be optimized may be taken as the center, and a preset number of position points may be uniformly selected within a limited distance around the position to be optimized, and each position point may be determined as a candidate transfer position to obtain a candidate transfer position group. Wherein, the preset limited distance may be half of the social distance threshold mentioned above. For example, when the social distance threshold is 0.6 meters, the preset distance may be 0.3 meters. The preset quantity may be the number of preset position points.

As an example, the position to be optimized may be taken as the center of a square, and eight position points may be uniformly selected on the edges of a square whose side length is 0.2 meters, and the various selected position point may be determined as a candidate transfer position group.

The second step is to determine an initial viewpoint score corresponding to the position to be optimized. Wherein, the initial viewpoint score may characterize the visual effect of visitors observing the target exhibit through VR equipment at the position to be optimized. The executing body may determine the initial viewpoint score corresponding to the position to be optimized through various means.

In certain optional implementations of some embodiments, the executing body may determine the initial viewpoint score corresponding to the position to be optimized through the following viewpoint score generation steps:
Step 1: Determine an exhibit observation plane corresponding to the position to be optimized. Wherein, the exhibit observation plane may be a plane that is perpendicular through the centroid of the target exhibit to a gaze projection line segment. The gaze projection line segment may be a line segment obtained by projecting the line connecting the position to be optimized and the centroid of the target exhibit onto the horizontal plane.
Step 2: Determine a visitor equipment visual area, an exhibit projection area, and a visual obstruction area corresponding to the exhibit observation plane. Wherein, the visitor equipment visual area may be a flat area that can be seen without visual obstruction when observing the exhibit observation plane through VR equipment at the position to be optimized. The exhibit projection area may be a flat area occupied by the projection of the target exhibit on the exhibit observation plane. The visual obstruction area may be a flat area corresponding to the obstructed part of the field of view when observing the exhibit observation plane through VR equipment.
Step 3: Determine the overlapping area between the visitor equipment visual area and the exhibit projection area as an exhibit area within visual field.
Step 4: Determine the ratio between the area of the exhibit area within visual field and the area of the visitor equipment visual area as an exhibit visual area proportion.
Step 5: Determine the ratio between the area of the exhibit area within the visual field and the area of the exhibit projection area as an exhibit visible area proportion.
Step 6: Determine the overlapping area between the visual obstruction area and the exhibit area within visual field as an exhibit obstruction area.
Step 7: Determine the difference between the area of the exhibit area within visual field and the area of the exhibit obstruction area as an unobstructed exhibit area.
Step 8: Determine the ratio between the areas of the unobstructed exhibit area and the exhibit area within visual field as an area proportion of the unobstructed exhibit area.
Step 9: Determine the visual color quality of the target exhibit. Wherein, the visual color quality may be the color richness of the target exhibit in the VR equipment's visual field. The visual color quality may be expressed by a percentage. A color richness measurement method based on color space distribution may be used to determine the visual color quality of the target exhibit.
Step 10: Determine the visual depth quality of the target exhibit. Wherein, the visual depth quality may characterize whether the depth of the target exhibit in the VR equipment's visual field is appropriate, not too far or too close. The visual depth quality may be expressed by a percentage. The visual depth quality of the target exhibit may be determined through a preset depth measurement method, adopting the depth measurement included in the collaborative operation method based on viewpoint quality assessment. For example, the depth measurement method may be, but is not limited to, one of the following: depth measurement method based on stereo vision, depth measurement method based on depth buffering, or depth measurement method based on ray projection.
Step 11: Perform weighted summation of the exhibit visual area proportion, the exhibit visible area proportion, the area proportion of the unobstructed exhibit area, the visual color quality, and the visual depth quality to obtain an initial viewpoint score corresponding to the position to be optimized. Wherein, the weights of linear superposition may be adjusted according to the actual scene, without fixed weights.

The third step is to determine a candidate viewpoint score corresponding to each candidate transfer position in the candidate transfer position group to obtain a candidate viewpoint score group. Wherein, the candidate viewpoint scores in the candidate viewpoint score group can characterize the visual effect of visitors observing the target exhibit through VR equipment at corresponding candidate transfer positions. For each candidate transfer position in the candidate transfer position group, the candidate transfer position may be used as the position to be optimized. The above viewpoint score generation step may be carried out to obtain an initial viewpoint score corresponding to the candidate transfer position as a candidate viewpoint score.

The fourth step four is, in response to determining that there is no target viewpoint score in the candidate viewpoint score group, determining the position to be optimized as the optimized visit position. Wherein, the target viewpoint score may be the maximum value in the candidate viewpoint score group that is greater than the initial viewpoint score.

Optionally, the executing body may also perform the following steps:
Step 1: Select a target viewpoint score from the candidate viewpoint score group in response to determining that there are target viewpoint scores in the candidate viewpoint score group, and use it as the optimized viewpoint score.
Step 2: Take the candidate transfer position corresponding to the optimized viewpoint score as the position to be optimized, and perform the above optimized visit position generating step again.

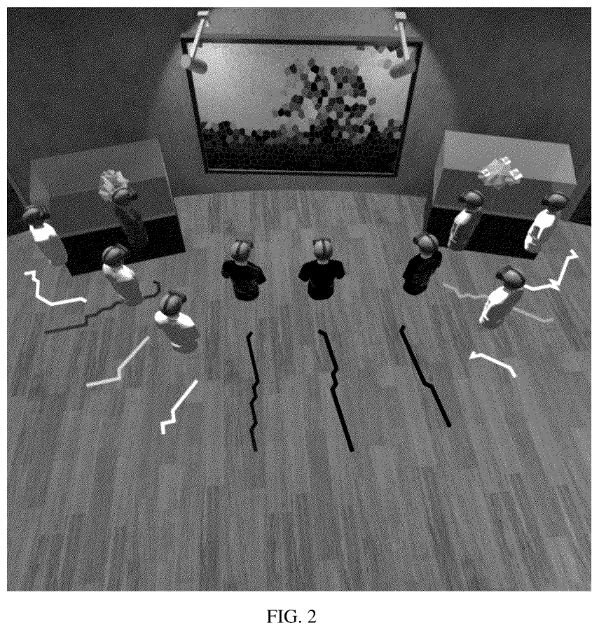

As an example, FIG. 2 illustrates a schematic diagram of the scene where an optimized visit position queue is generated in a circular exhibit area of the automated formation group guidance method based on scene perception according to this disclosure. In FIG. 2, the target exhibit area is a circular exhibit area. FIG. 2 includes 10 trajectory lines and one visitor group consisting of 10 visitors. The position of the end of each trajectory line that is away from the target exhibit is the initial visit position, while the position of the end that is close to the target exhibit is the optimized visit position. The distribution of the initial visit positions of each trajectory line may be regarded as an approximately uniform circular distribution. Each trajectory line can characterize the position optimization process from the initial visit position to the optimized visit position. Each trajectory line can correspond to visitors in the visitor group one by one. The position where each visitor observes the target exhibit is the optimized visit position after position optimization.

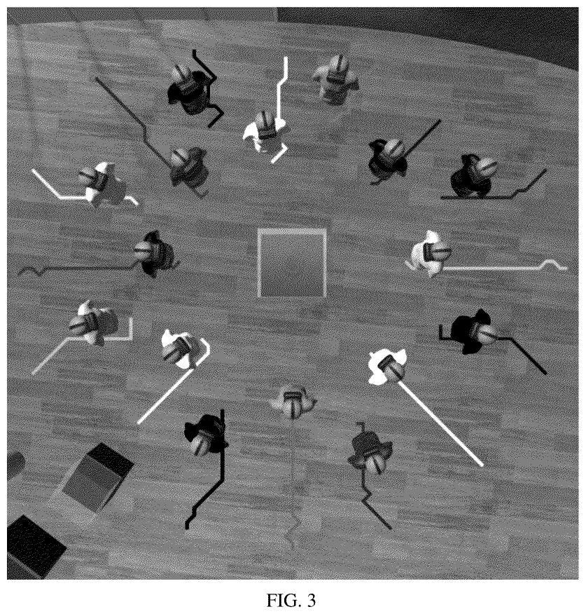

As an example, FIG. 3 illustrates a schematic diagram of the scene where an optimized visit position queue is generated in an arc-shaped exhibit area of the automated formation group guidance method based on scene perception according to this disclosure. In FIG. 3, the target exhibit area is an arc-shaped exhibit area. FIG. 3 includes 16 trajectory lines and one visitor group consisting of 16 visitors. The position of the end of each trajectory line that is away from the target exhibit is the initial visit position, while the position of the end that is close to the target exhibit is the optimized visit position. The distribution of the initial visit positions of each trajectory line may be regarded as an approximately uniform arc-shaped distribution. Each trajectory line can characterize the position optimization process from the initial visit position to the optimized visit position. Each trajectory line can correspond to visitors in the visitor group one by one. The position where each visitor observes the target exhibit is the optimized visit position after position optimization.

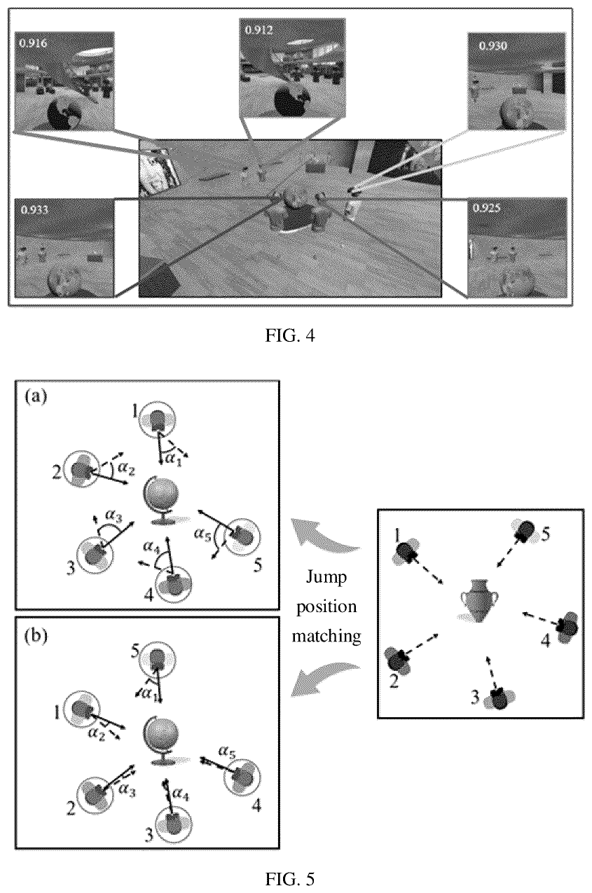

As an example, FIG. 4 illustrates a schematic diagram of each viewpoint score corresponding to the optimized visit position queue of the automated formation group guidance method based on scene perception according to this disclosure. Wherein, FIG. 4 includes five subgraphs and one panoramic view of the browsing area. Each subgroup corresponds to the visitors in the panoramic view one by one. Each subgraph displays the images seen by the corresponding visitor through VR glasses at the optimized visit position, as well as the viewpoint score corresponding to the optimized visit position. The viewpoint scores displayed in the five subgraphs are 0.916, 0.912, 0.930, 0.925, and 0.933, respectively.
Step 104: Based on a preset matching strategy, matching the optimized visit position queue and the current visitor position information queue to obtain a target visitor position information queue, for guiding each visitor in the visitor group to perform position jumps and browse target exhibits.

In some embodiments, the executing body may, based on a preset matching strategy, match the optimized visit position queue and the current visitor position information queue to obtain a target visitor position information queue, for guiding each visitor in the visitor group to perform position jumps and browse target exhibits. Wherein, the matching strategy may be to minimize the sum of the various position deflection angles of the respective visitors. The position deflection angle may be the angle between the position orientation before jump and the position orientation after jump of the visitor, which is less than a preset degree. The preset degree may be a degree set in advance, for example, the preset degree may be 180 degrees. The matching strategy may correspond to a preset objective function. The preset objective function may be a function set in advance that minimizes the sum of the position deviation angles of each visitor before and after the next jump. The current visitor position information queue mentioned above may be a formation composed of the current positions of each visitor in the virtual scene. The current visitor position information in the current visitor position information queue may include a visitor ID and the current position information. The visitor ID may be the unique ID of the visitor. The current position information may be the information corresponding to the visitor's position in the browsing area at the current time before the next jump starts. The target visitor position information in the target visitor position information queue may be the information corresponding to the visitor's landing point position for the next jump. Firstly, the preset objective function may be solved using a preset optimization method to obtain an optimized visit position corresponding to each current visitor position information. Then, for each current visitor position information in the optimized visitor position queue, the optimized visitor position and the visitor ID corresponding to the current visitor position information are determined as the target visitor position information. In the end, each visitor uses virtual reality techniques to jump to the vicinity of the target exhibit based on the corresponding target visitor position information, and observes the target exhibit through VR equipment.

As an example, the above optimization method may be, but is not limited to, one of the following: gradient descent method, least squares method.

As an example, FIG. 5 is a schematic diagram of the comparison before and after position jump of the automated formation group guidance method based on scene perception according to this disclosure. Wherein, FIG. 5 includes a right side subgraph, a left side subgraph (a), and the left side subgraph (b), as well as five visitors indicated by numbers 1, 2, 3, 4, and 5. The right side subgraph shows the position and orientation of each visitor before jump. The left side subgraph (a) and left side subgraph (b) respectively show the results of five visitor jumps using different position matching strategies. Wherein, in the left side subgraph (a) and left side subgraph (b), the position deviation angles before and after five visitor jumps may be represented by α₁, α₂, α₃, α₄, and α₅, respectively. The left side subgraph (a) shows a random jump result of five visitors obtained without using the matching strategy of this disclosure. The left side subgraph (b) shows the position jump results of give visitors obtained after using the matching strategy of this disclosure. By comparing the position deviation angles of the five visitors in the left side subgraph (a) and left side subgraph (b), it may be seen that the position deviation angles of the five visitors in the left side subgraph (b) using the matching strategy of this disclosure are relatively small, which can reduce the probability of 3D dizziness for visitors and improve the exhibit viewing experience.

Alternatively, the executing body may also generate a transition queue based on the jump position information in response to determining that the jump position is not within any exhibit area. Wherein, the transition queue may be a sequential queue composed of various transition jump positions. Each transition jump position may be a position of temporary stop for visitors during the process of jumping from the vicinity of one exhibit to the vicinity of another exhibit. The transition queue can also meet the preset visitor position condition set mentioned above. The jump position corresponding to the jump position information may be used as the first element of the sequential queue. Based on the social distance threshold and the queue length, a transition queue that meets the preset visitor position condition set may be generated by a method of approximating a square array. To be specific, the method of approximating a square array may be as follows: generating a formation square array at the transition jump position with social distance thresholds as intervals (2*2 array for 1-4 people, 3*3 array for 5-9 people, and so on). For example, when the jump position is (x, y) and the social distance threshold is 0.3, for a group of five visitors, the jump positions of the five visitors may be (x+0.3, y−0.3), (x+0.3, y), (x+0.3, y+0.3), (x, y−0.3), and (x, y), respectively.

To continue, after generating a transition queue, the matching strategy may be used to match the transition queue with the current visitor position information queue to obtain the target visitor position information queue, for guiding each visitor in the visitor group to jump to the corresponding transition jump position.

It should be noted that, as the guide continuously selects the next jump position through a VR controller, the automated formation group guidance method based on scene perception of this disclosure can continuously generate target visitor position information queues for the visitor group, to guide each visitor in the visitor group to browse various exhibits. In addition, the guide can choose the order of visiting the exhibits according to the actual situation, and can guide visitors to visit the exhibits repeatedly.

The above embodiments of this disclosure have the following beneficial effects: through the automated formation group guidance method based on scene perception in some embodiments of this disclosure, the efficiency of group navigation may be improved. To be specific, in order to solve the technical problem of “reduced efficiency of group navigation” mentioned in the background section, the automated formation group guidance method based on scene perception in some embodiments of this disclosure, after the guide determines the next target exhibit to be viewed, first generates an initial visit position queue for the visitor group based on the jump position corresponding to the target exhibit selected by the guide, then optimizes the position of the initial visit position queue to obtain an optimized visit position queue, thus obtains various viewpoint positions with higher view quality when viewing exhibits, for subsequent allocation to each visitor, and in the end, based on a preset matching strategy, matches the optimized visit position queue and the current visitor position information queue to obtain a target visitor position information queue, for guiding each visitor in the visitor group to perform position jumps and browse target exhibits, wherein the matching strategy is to minimize the sum of the position deflection angles before and after all visitor jumps. Therefore, each visitor can match and jump to an optimized visit position with higher view quality, for better observation of the target exhibits. Therefore, the automated formation group guidance method based on scene perception in some embodiments of this disclosure can simplify the operation of the guide in planning the navigation route and the user's viewing position, reduce the burden and fatigue of the guide, and improve the efficiency of group navigation by automatically generating various jump positions with better exhibit observation effects for the visitor group after the guide selects a jump position. Also, because the view quality corresponding to each optimized visit position is relatively high, it can improve the viewing experience of visitors when viewing exhibits. In addition, by adopting the strategy of minimizing the sum of the position deviation angles before and after all visitor jumps, matching and optimizing the visit position for each visitor can also significantly reduce the probability of 3D (three-dimensional) dizziness caused by excessive position deviation angles before and after jumps, thereby further improving the viewing experience of visitors.

The technical content not elaborated on in this disclosure belongs to the well-known technology of those skilled in the art.

The above description is merely some preferred embodiments of this disclosure and illustrations of the applied technical principles. Those skilled in the art should understand that the scope of the invention involved in the embodiments of this disclosure is not limited to the technical solutions formed by the specific combination of the above technical features, but should cover at the same time, without departing from the above inventive concept, other technical solutions formed by any combination of the above technical features or their equivalent features, for example, a technical solution formed by replacing the above features with the technical features of similar functions disclosed (but not limited to) in the embodiments of this disclosure.

1. An automated formation group guidance method based on scene perception, comprising:
in response to receiving jump position information for a browsing area, determining whether a jump position corresponding to the jump position information is within any exhibit area, wherein the browsing area includes a non-exhibit area and at least one exhibit area, and each exhibit area in the at least one exhibit area corresponds to an exhibit;
in response to determining that the jump position is within the any exhibit area, based on a preset social distance threshold and a queue length, determining an initial visit position queue corresponding to a target exhibit, where the target exhibit is an exhibit exhibited in a target exhibit area, the target exhibit area is an exhibit area that includes the jump position, and the queue length is a number of respective visitors in a visitor group;
optimizing each initial visit position in the initial visit position queue to obtain an optimized visit position queue, wherein each optimized visit position in the optimized visit position queue is a viewpoint position with a higher quality of a view, the view being an image when viewing the exhibit through virtual reality equipment;
based on a preset matching strategy, matching the optimized visit position queue and a current visitor position information queue to obtain a target visitor position information queue, for guiding each visitor in the visitor group to perform position jumps and browse target exhibits, wherein the matching strategy is to minimize a sum of various position deflection angles of the respective visitors, and a position deflection angle is an angle between a position orientation before jump and a position orientation after jump of a visitor, which is less than a preset degree.

2. The method of claim 1, wherein, the method further comprises:
generating a transition queue based on the jump position information in response to determining that the jump position is not within the any exhibit area, wherein, the transition queue is a sequential queue composed of various transition jump positions, and each transition jump position is a position of temporary stop for visitors during a process of jumping from a vicinity of one exhibit to a vicinity of another exhibit.

3. The method of any of claim 1-2, wherein, each visitor in the visitor group meets a preset visitor position condition set, the preset visitor position condition set includes:
condition 1: in response to determining that the jump position is within the any exhibit area, each visitor in the visitor group faces a centroid of the target exhibit;
condition 2: a straight-line distance between positions of any two visitors in the visitor group is not less than the social distance threshold;
condition 3: each visitor in the visitor group does not collide with obstacles.

4. The method of claim 3, wherein, the based on a preset social distance threshold and a queue length, determining an initial visit position queue corresponding to a target exhibit, includes:
determining whether a shape of the target exhibit area is circular or arc-shaped;
in response to determining that the shape of the target exhibit area is circular, determining a radius of the circular area based on the preset social distance threshold and queue length, wherein, the radius of the circular area is generated using the following formula:
$$r 1 = d / 2 sin ( π / n ) ,$$
wherein, r1 represents the radius of the circular area, d represents the social distance threshold, n represents a number of visit positions corresponding to the queue length, and sin(⋅) represents a sine function;
based on the radius of the circular area and the queue length, determining the initial visit position queue corresponding to the target exhibit, wherein, the initial visit position in the initial visit position queue is generated by the following formula:
$$P [ i ] = e . p + r 1 \cdot ( cos ( 2 π \times i / n ) , sin ( 2 π \times i / n ) ) ,$$
wherein, P represents the initial visit position queue, i represents a sequence number of the initial visit positions in the initial visit position queue, P[i] represents a ith initial visit position in the initial visit position queue, e represents the target exhibit, P represents a position point, e.p represents a position of the exhibit, cos(⋅) represents a cosine function;
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 1 - Δ ) \cdot ( cos ( 2 π \times \frac{i}{n} ) , sin ( 2 π \times \frac{i}{n} ) ) , \\ Δ = Δ + δ\end{matrix}$$
wherein, δ represents an amount of change in the distance that the initial visit position moves towards the target exhibit during each iterative update, A represents the distance of movement that the initial visit position accumulates towards the target exhibit after each iterative update.

5. The method of claim 4, wherein, the method further comprising:
in response to determining that the shape of the target exhibit area is arc-shaped, determining a radius of the arc-shaped area based on the social distance threshold and the queue length, wherein, the radius of the arc-shaped area is generated using the following formula:
$$r 2 = d / 2 sin ( \frac{{φ}_{1} - {φ}_{2}}{2 ( n - 1 )} ) ,$$
wherein, r2 represents the radius of the arc-shaped area, φ represents an angle, and in the target exhibit area, φ₁ represents an obtuse or right angle formed by a wall on one side of the target exhibit and a plane where a centroid of the target exhibit is located, φ₂ represents an acute angle formed between a wall on the other side of the target exhibit and the plane where the centroid of the target exhibit is located, φₑ-φₛ represents an angle between walls on both sides of the target exhibit;
based on the radius of the arc-shaped area and the queue length, determining the initial visiting position queue corresponding to the target exhibit, wherein, the initial visit position in the initial visit position queue is generated by the following formula:
$$P [ i ] = e . p + r 2 \cdot ( cos ( \frac{i \times ( {φ}_{1} - {φ}_{2} )}{n - 1} ) , sin ( \frac{i \times ( {φ}_{1} - {φ}_{2} )}{n - 1} ) ) ;$$
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 2 - Δ ) \cdot ( cos ( \frac{i \times ( {φ}_{1} - {φ}_{2} )}{n - 1} ) , sin ( \frac{i \times ( {φ}_{1} - {φ}_{2} )}{n - 1} ) ) . \\ Δ = Δ + δ\end{matrix}$$

6. The method of claim 3, wherein, the optimizing each initial visit position in the initial visit position queue to obtain an optimized visit position queue includes:
performing the following steps for each initial visit position in the initial visit position queue:
taking the initial visit position as a position to be optimized, and based on the position to be optimized, performing the following optimized visit position generating steps:
determining a candidate transfer position group corresponding to the position to be optimized;
determining an initial viewpoint score corresponding to the position to be optimized;
determining a candidate viewpoint score corresponding to each candidate transfer position in the candidate transfer position group to obtain a candidate viewpoint score group;
in response to determining that there is no target viewpoint score in the candidate viewpoint score group, determining the position to be optimized as the optimized visit position, wherein, the target viewpoint score is a maximum value in the candidate viewpoint score group that is greater than the initial viewpoint score.

7. The method of claim 6, wherein, the method further comprising:
selecting the target viewpoint score from the candidate viewpoint score group in response to determining that there are target viewpoint scores in the candidate viewpoint score group, as the optimized viewpoint score;
taking the candidate transfer position corresponding to the optimized viewpoint score as the position to be optimized, and performing the optimized visit position generating step again.

8. The method of claim 7, wherein, the determining an initial viewpoint score corresponding to the position to be optimized includes:
determining an exhibit observation plane corresponding to the position to be optimized;
determining a visitor equipment visual area, an exhibit projection area, and a visual obstruction area corresponding to the exhibit observation plane;
determining an overlapping area between the visitor equipment visual area and the exhibit projection area as an exhibit area within visual field;
determining a ratio between an area of the exhibit area within visual field and an area of the visitor equipment visual area as an exhibit visual area proportion;
determining a ratio between the area of the exhibit area within the visual field and an area of the exhibit projection area as an exhibit visible area proportion;
determining an overlapping area between the visual obstruction area and the exhibit area within visual field as an exhibit obstruction area;
determining a difference between the area of the exhibit area within visual field and the area of the exhibit obstruction area as an unobstructed exhibit area;
determining a ratio between areas of the unobstructed exhibit area and the exhibit area within visual field as an area proportion of the unobstructed exhibit area;
determining a visual color quality of the target exhibit;
determining a visual depth quality of the target exhibit;
performing weighted summation of the exhibit visual area proportion, the exhibit visible area proportion, the area proportion of the unobstructed exhibit area, the visual color quality, and the visual depth quality to obtain the initial viewpoint score corresponding to the position to be optimized.

1. An automated formation group guidance method based on scene perception, comprising:
in response to receiving jump position information for a browsing area, determining whether a jump position corresponding to the jump position information is within any exhibit area, wherein the browsing area includes a non-exhibit area and at least one exhibit area, and each exhibit area in the at least one exhibit area corresponds to an exhibit;
in response to determining that the jump position is within the any exhibit area, based on a preset social distance threshold and a queue length, determining an initial visit position queue corresponding to a target exhibit, where the target exhibit is an exhibit exhibited in a target exhibit area, the target exhibit area is an exhibit area that includes the jump position, and the queue length is a number of respective visitors in a visitor group;
optimizing each initial visit position in the initial visit position queue to obtain an optimized visit position queue, wherein each optimized visit position in the optimized visit position queue is a viewpoint position with a higher quality of a view, the view being an image when viewing the exhibit through virtual reality equipment;
based on a preset matching strategy, matching the optimized visit position queue and a current visitor position information queue to obtain a target visitor position information queue, for guiding each visitor in the visitor group to perform position jumps and browse target exhibits, wherein the matching strategy is to minimize a sum of various position deflection angles of the respective visitors, and a position deflection angle is an angle between a position orientation before jump and a position orientation after jump of a visitor, which is less than a preset degree.

2. The method of claim 1, wherein, the method further comprises:
generating a transition queue based on the jump position information in response to determining that the jump position is not within the any exhibit area, wherein, the transition queue is a sequential queue composed of various transition jump positions, and each transition jump position is a position of temporary stop for visitors during a process of jumping from a vicinity of one exhibit to a vicinity of another exhibit.

3. The method of claim 1, wherein, each visitor in the visitor group meets a preset visitor position condition set, the preset visitor position condition set comprises:
condition 1: in response to determining that the jump position is within the any exhibit area, each visitor in the visitor group faces a centroid of the target exhibit;
condition 2: a straight-line distance between positions of any two visitors in the visitor group is not less than the social distance threshold;
condition 3: each visitor in the visitor group does not collide with obstacles.

4. The method of claim 3, wherein, the based on a preset social distance threshold and a queue length, determining an initial visit position queue corresponding to a target exhibit, comprises:
determining whether a shape of the target exhibit area is circular or arc-shaped;
in response to determining that the shape of the target exhibit area is circular, determining a radius of the circular area based on the preset social distance threshold and queue length, wherein, the radius of the circular area is generated using the following formula:
$$r 1 = d / 2 sin ( π / n ) ,$$
wherein, r1 represents the radius of the circular area, d represents the social distance threshold, n represents a number of visit positions corresponding to the queue length, and sin(⋅) represents a sine function;
based on the radius of the circular area and the queue length, determining the initial visit position queue corresponding to the target exhibit, wherein, the initial visit position in the initial visit position queue is generated by the following formula:
$$P [ i ] = e . p + r 1 \cdot ( cos ( 2 π \times i / n ) , sin ( 2 π \times i / n ) ) ,$$
wherein, P represents the initial visit position queue, i represents a sequence number of the initial visit positions in the initial visit position queue, P[i] represents a i^{th} initial visit position in the initial visit position queue, e represents the target exhibit, P represents a position point, e. p represents a position of the exhibit, cos(⋅) represents a cosine function;
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 1 - Δ ) \cdot ( cos ( 2 π \times \frac{i}{n} ) , sin ( 2 π \times \frac{i}{n} ) ) , \\ Δ = Δ + δ\end{matrix}$$
wherein, δ represents an amount of change in the distance that the initial visit position moves towards the target exhibit during each iterative update, A represents the distance of movement that the initial visit position accumulates towards the target exhibit after each iterative update.

5. The method of claim 4, wherein, the method further comprising:
in response to determining that the shape of the target exhibit area is arc-shaped, determining a radius of the arc-shaped area based on the social distance threshold and the queue length, wherein, the radius of the arc-shaped area is generated using the following formula:
$$r 2 = d / 2 sin ( \frac{{φ}_{1} - {φ}_{2}}{2 ( n - 1 )} ) ,$$
wherein, r2 represents the radius of the arc-shaped area, φ represents an angle, and in the target exhibit area, φ₁ represents an obtuse or right angle formed by a wall on one side of the target exhibit and a plane where a centroid of the target exhibit is located, φ₂ represents an acute angle formed between a wall on the other side of the target exhibit and the plane where the centroid of the target exhibit is located, φₑ- φₛ represents an angle between walls on both sides of the target exhibit;
based on the radius of the arc-shaped area and the queue length, determining the initial visiting position queue corresponding to the target exhibit, wherein, the initial visit position in the initial visit position queue is generated by the following formula:
$$P [ i ] = e . p + r 2 \cdot ( cos ( \frac{i \times ( {φ}_{1} - {φ}_{2} )}{n - 1} ) , sin ( \frac{i \times ( {φ}_{1} - {φ}_{2} )}{n - 1} ) ) ;$$
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 2 - Δ ) \cdot ( cos ( \frac{i \times ( {φ}_{1} - {φ}_{2} )}{n - 1} ) , sin ( \frac{i \times ( {φ}_{1} - {φ}_{2} )}{n - 1} ) ) . \\ Δ = Δ + δ\end{matrix}$$

6. The method of claim 3, wherein, the optimizing each initial visit position in the initial visit position queue to obtain an optimized visit position queue comprises:
performing the following steps for each initial visit position in the initial visit position queue:
taking the initial visit position as a position to be optimized, and based on the position to be optimized, performing the following optimized visit position generating steps:
determining a candidate transfer position group corresponding to the position to be optimized;
determining an initial viewpoint score corresponding to the position to be optimized;
determining a candidate viewpoint score corresponding to each candidate transfer position in the candidate transfer position group to obtain a candidate viewpoint score group;
in response to determining that there is no target viewpoint score in the candidate viewpoint score group, determining the position to be optimized as the optimized visit position, wherein, the target viewpoint score is a maximum value in the candidate viewpoint score group that is greater than the initial viewpoint score.

7. The method of claim 6, wherein, the method further comprising:
selecting the target viewpoint score from the candidate viewpoint score group in response to determining that there are target viewpoint scores in the candidate viewpoint score group, as the optimized viewpoint score;
taking the candidate transfer position corresponding to the optimized viewpoint score as the position to be optimized, and performing the optimized visit position generating step again.

8. The method of claim 7, wherein, the determining an initial viewpoint score corresponding to the position to be optimized comprises:
determining an exhibit observation plane corresponding to the position to be optimized;
determining a visitor equipment visual area, an exhibit projection area, and a visual obstruction area corresponding to the exhibit observation plane;
determining an overlapping area between the visitor equipment visual area and the exhibit projection area as an exhibit area within visual field;
determining a ratio between an area of the exhibit area within visual field and an area of the visitor equipment visual area as an exhibit visual area proportion;
determining a ratio between the area of the exhibit area within the visual field and an area of the exhibit projection area as an exhibit visible area proportion;
determining an overlapping area between the visual obstruction area and the exhibit area within visual field as an exhibit obstruction area;
determining a difference between the area of the exhibit area within visual field and the area of the exhibit obstruction area as an unobstructed exhibit area;
determining a ratio between areas of the unobstructed exhibit area and the exhibit area within visual field as an area proportion of the unobstructed exhibit area;
determining a visual color quality of the target exhibit;
determining a visual depth quality of the target exhibit;
performing weighted summation of the exhibit visual area proportion, the exhibit visible area proportion, the area proportion of the unobstructed exhibit area, the visual color quality, and the visual depth quality to obtain the initial viewpoint score corresponding to the position to be optimized.

9. The method of claim 2, wherein, each visitor in the visitor group meets a preset visitor position condition set, the preset visitor position condition set comprises:
condition 1: in response to determining that the jump position is within the any exhibit area, each visitor in the visitor group faces a centroid of the target exhibit;
condition 2: a straight-line distance between positions of any two visitors in the visitor group is not less than the social distance threshold;
condition 3: each visitor in the visitor group does not collide with obstacles.

10. The method of claim 9, wherein, the based on a preset social distance threshold and a queue length, determining an initial visit position queue corresponding to a target exhibit, comprises:
determining whether a shape of the target exhibit area is circular or arc-shaped;
in response to determining that the shape of the target exhibit area is circular, determining a radius of the circular area based on the preset social distance threshold and queue length, wherein, the radius of the circular area is generated using the following formula:
$$r 1 = d / 2 sin ( π / n ) ,$$
wherein, r1 represents the radius of the circular area, d represents the social distance threshold, n represents a number of visit positions corresponding to the queue length, and sin(⋅) represents a sine function;
based on the radius of the circular area and the queue length, determining the initial visit position queue corresponding to the target exhibit, wherein, the initial visit position in the initial visit position queue is generated by the following formula:
$$P [ i ] = e . p + r 1 \cdot ( cos ( 2 π \times i / n ) , sin ( 2 π \times i / n ) ) ,$$
wherein, P represents the initial visit position queue, i represents a sequence number of the initial visit positions in the initial visit position queue, P[i] represents a i^{th} initial visit position in the initial visit position queue, e represents the target exhibit, P represents a position point, e.p represents a position of the exhibit, cos(⋅) represents a cosine function;
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 1 - Δ ) \cdot ( cos ( 2 π \times \frac{i}{n} ) , sin ( 2 π \times \frac{i}{n} ) ) , \\ Δ = Δ + δ\end{matrix}$$
wherein, δ represents an amount of change in the distance that the initial visit position moves towards the target exhibit during each iterative update, Δ represents the distance of movement that the initial visit position accumulates towards the target exhibit after each iterative update.

11. The method of claim 10, wherein, the method further comprising:
in response to determining that the shape of the target exhibit area is arc-shaped, determining a radius of the arc-shaped area based on the social distance threshold and the queue length, wherein, the radius of the arc-shaped area is generated using the following formula:
$$r 2 = d / 2 sin ( \frac{{φ}_{1} - {φ}_{2}}{2 ( n - 1 )} ) ,$$
wherein, r2 represents the radius of the arc-shaped area, φ represents an angle, and in the target exhibit area, φ₁ represents an obtuse or right angle formed by a wall on one side of the target exhibit and a plane where a centroid of the target exhibit is located, φ₂ represents an acute angle formed between a wall on the other side of the target exhibit and the plane where the centroid of the target exhibit is located, φₑ-φₛ represents an angle between walls on both sides of the target exhibit;
based on the radius of the arc-shaped area and the queue length, determining the initial visiting position queue corresponding to the target exhibit, wherein, the initial visit position in the initial visit position queue is generated by the following formula:
$$P [ i ] = e . p + r 2 \cdot ( cos ( \frac{i \times ( {φ}_{1} - {φ}_{2} )}{n - 1} ) , sin ( \frac{i \times ( {φ}_{1} - {φ}_{2} )}{n - 1} ) ) ;$$
for each initial visit position in the initial visit position queue, in response to determining presence of obstacles at the initial visit position, iteratively updating the initial visit position using the following formula to obtain the initial visit position that meets the condition 3:
$$\{ \begin{matrix}P [ i ] = e . p + ( r 2 - Δ ) \cdot ( cos ( \frac{i \times ( {φ}_{1} - {φ}_{2} )}{n - 1} ) , sin ( \frac{i \times ( {φ}_{1} - {φ}_{2} )}{n - 1} ) ) . \\ Δ = Δ + δ\end{matrix}$$

12. The method of claim 9, wherein, the optimizing each initial visit position in the initial visit position queue to obtain an optimized visit position queue comprises:
performing the following steps for each initial visit position in the initial visit position queue:
taking the initial visit position as a position to be optimized, and based on the position to be optimized, performing the following optimized visit position generating steps:
determining a candidate transfer position group corresponding to the position to be optimized;
determining an initial viewpoint score corresponding to the position to be optimized;
determining a candidate viewpoint score corresponding to each candidate transfer position in the candidate transfer position group to obtain a candidate viewpoint score group;
in response to determining that there is no target viewpoint score in the candidate viewpoint score group, determining the position to be optimized as the optimized visit position, wherein, the target viewpoint score is a maximum value in the candidate viewpoint score group that is greater than the initial viewpoint score.

13. The method of claim 12, wherein, the method further comprising:
selecting the target viewpoint score from the candidate viewpoint score group in response to determining that there are target viewpoint scores in the candidate viewpoint score group, as the optimized viewpoint score;
taking the candidate transfer position corresponding to the optimized viewpoint score as the position to be optimized, and performing the optimized visit position generating step again.

14. The method of claim 13, wherein, the determining an initial viewpoint score corresponding to the position to be optimized comprises:
determining an exhibit observation plane corresponding to the position to be optimized;
determining a visitor equipment visual area, an exhibit projection area, and a visual obstruction area corresponding to the exhibit observation plane;
determining an overlapping area between the visitor equipment visual area and the exhibit projection area as an exhibit area within visual field;
determining a ratio between an area of the exhibit area within visual field and an area of the visitor equipment visual area as an exhibit visual area proportion;
determining a ratio between the area of the exhibit area within the visual field and an area of the exhibit projection area as an exhibit visible area proportion;
determining an overlapping area between the visual obstruction area and the exhibit area within visual field as an exhibit obstruction area;
determining a difference between the area of the exhibit area within visual field and the area of the exhibit obstruction area as an unobstructed exhibit area;
determining a ratio between areas of the unobstructed exhibit area and the exhibit area within visual field as an area proportion of the unobstructed exhibit area;
determining a visual color quality of the target exhibit;
determining a visual depth quality of the target exhibit;
performing weighted summation of the exhibit visual area proportion, the exhibit visible area proportion, the area proportion of the unobstructed exhibit area, the visual color quality, and the visual depth quality to obtain the initial viewpoint score corresponding to the position to be optimized.
